(19) United States
(12) Patent Application Publication
(10) Pub. No.: US 2003/0184869 A1
(43) Pub. Date: Oct. 2, 2003

(54) Light focusing and dispersing apparatus of light source module

(76) Inventors: Chen-Ho Lee, Hsin-Chu City (TW); Tsung-Yin Chen, Hsin-Chu City (TW); Chun-I Hsiao, Hsin-Chu City (TW)

Correspondence Address: POWELL, GOLDSTEIN, FRAZER & MURPHY LLP, P.O. BOX 97223, WASHINGTON, DC, 20090-7223, US

(21) Appl. No.: 10/109,890

(22) Filed: Apr. 1, 2002

(51) Int. Cl. G02B 27/14; G02B 27/12; G02B 5/04; G02B 7/18

(52) U.S. Cl. 359/634; 359/831

(57) ABSTRACT

A light focusing and dispersing apparatus of a light source module is disclosed. The light focusing and dispersing apparatus is particularly used in image scanners such as a single pass color scanner. The light focusing and dispersing apparatus concentrates light from a light source to form a light beam so as to upgrade the use efficiency of light energy. The light focusing and dispersing apparatus disperses the light beam from the light source to form red, green and blue light beams to illuminate a document to be scanned. The red, green and blue light beams reflected from the scanned document emit onto array of image sensors comprising red, green and blue light sensitive regions respectively.

### BACKGROUND OF THE INVENTION

1. Field of the Invention

The present invention relates to a light focusing and dispersing apparatus of a light source module, and more particularly to a light focusing and dispersing apparatus of a light source module disposed in an image scanner.

2. Description of the Related Art

Image scanners (image scanning and reading devices) are being increasingly used for the purpose of optically reading a given objective image by use of an image sensor such as a CCD line sensor and outputting image signals to various image processing devices including a computer, a copying machine and a facsimile. A cold-cathode fluorescent lamp (CCFL), which is generally used as a light source in the image scanner especially for a single pass color image scanner, has suffered a disadvantage that the utility rate of light source is low and most light energy is wasted. In order to attain a certain degree of intensity of illumination, the lamp current or the number of lamp must be increased thereby the lift time of the lamps is reduced and the cost is increased.

Furthermore, if a light source with a weaker brightness such as light-emitting diodes (LED) is utilized, the light energy emitted from the light source illuminating a document to be scanned may not be strong enough so that image sensors for sensing light reflected from the document may not receive light signals intense enough and thus the image quality could be poor.

In view of the drawbacks mentioned with the prior art, there is a continued need to develop a new and improved light source module of image scanner that overcome the disadvantages associated with prior art. The requirements of this invention are that it solves the problems mentioned above.

### SUMMARY OF THE INVENTION

It is therefore an object of the invention to provide a capability of selecting various light source including light-emitting diodes (LED) and a cold cathode fluorescent lamp (CCFL) without degrading the intensity of illumination and increasing the cost.

It is another object of this invention to prolong the life of light sources and upgrade the efficiency of the light sources and thus benefits the environment protection.

It is yet another object of this invention to render the utilization of light source of an image processing apparatus with weaker brightness such as LED practical.

To achieve these objects, and in accordance with the purpose of the invention, the invention provide a light focusing and dispersing apparatus of a light source module. The light focusing and dispersing apparatus of a light source module comprise a holder having a light source, and a light focusing and dispersing mean for concentrating light emitting from said light source to form a light beam and dispersing said light beam to form red, green and blue light beams illuminating a document to be scanned, wherein said red, green and blue light beams reflect to a plurality arrays of image sensors.

The invention also provides a light source module having a light focusing apparatus, the light source module comprises a holder having a light source emitting and a light-dispersing mean, wherein said light-dispersing mean disperses the light from the light source to form red, green and blue light beams illuminating a document to be scanned and being reflected by the document and emitting into a plurality arrays of image sensors, each array comprising a red light sensitive region, a green light sensitive region and a blue light sensitive region for sensing said red, green and blue light beams respectively.

It is to be understood that both the foregoing general description and the following detailed description are exemplary and explanatory only and are not restrictive of the invention, as claimed.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 shows a light source module of an image processing apparatus emitting light on a document amid scanning;

FIG. 2 shows a light-dispersing mean dispersing a focused and concentrated light beam from a light-focusing mean and emitting red, green and blue light beams; and

FIG. 3 shows a typical array of sensor comprising a red light sensitive region, a green light sensitive region and a blue light sensitive region.

### DESCRIPTION OF THE PREFERRED EMBODIMENT

It is to be understood and appreciated that the image compensation method of an image scanner described below does not cover a complete system and method. The present invention can be practiced in conjunction with various software and hardware that are components and steps are included herein as are necessary to provide an understanding of the present invention.

The present invention will be described in detail with reference to the accompanying drawings. It should be noted that the drawings are in greatly simplified form.

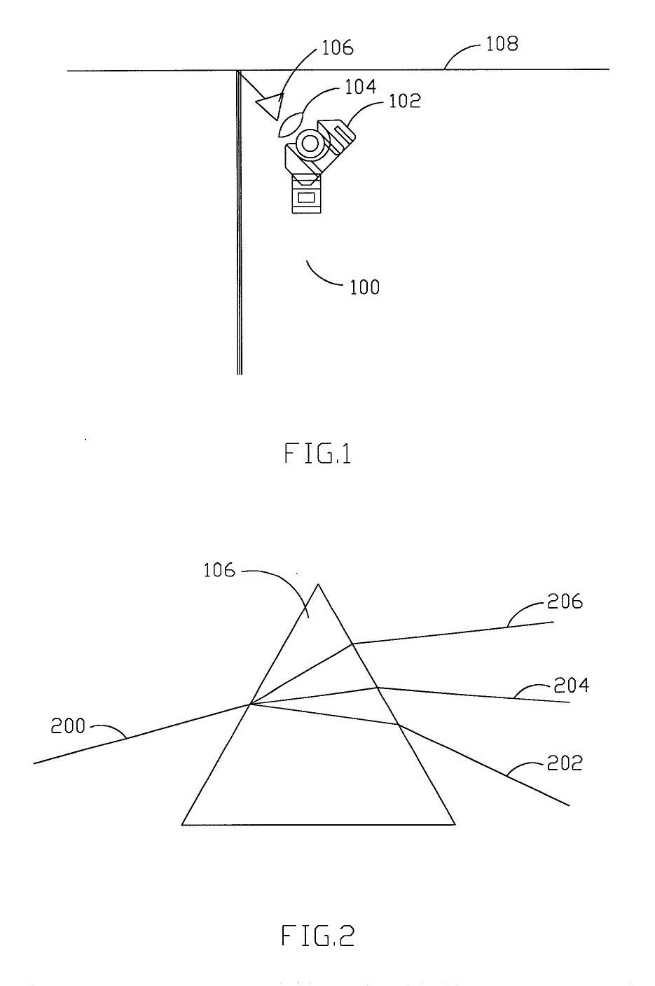

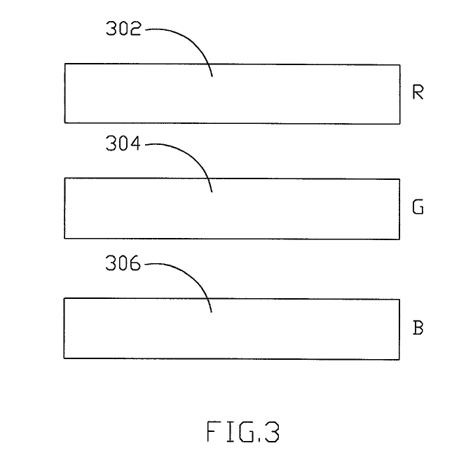

Referring to FIG. 1, a light source module 100 of an image processing apparatus such as an image scanner emitting light on a document 108 amid scanning is shown. The light source module 100 comprises a light source disposed in a holder 102, a light-focusing mean 104 and a light-dispersing mean 106. The light focusing mean 104 and a light-dispersing mean 106. The light source comprises light-emitting diodes. The light source could also be conventional cold cathode fluorescent lamp (CCFL). The light focusing mean 104 preferably comprises a light-focusing lens such as a convex lens or a bioconvex lens, but other mean for focusing lens such as a bioconvex lens a grating lens can also be utilized although the light-focusing mean 104 shown in FIG. 1 seems to be biconvex lens. The light-focusing mean 104 is used to focus or concentrate the scattering light emitted from the light source of the holder 102 to form a light beam. That is, the light-focusing mean 104 collects and concentrates the light energy from the light source thereby the light-focusing mean 104 can utilize the light energy more efficiently, no matter what the light source is, either light-emitting diodes or a conventional cold-cathode fluorescent lamp. The light-dispersing mean 106 preferably comprises a prism as shown in FIG. 1, but other means that can disperse the light from the light source should not be excluded. The light-dispersing mean 106 disperses the focuses and concentrated light beam 200 from the light-focusing mean 104 and emits red light beam 202, green light beam 204 and blue light beam 206 onto the document 108 as shown in FIG. 2. The light-dispersing mean 106 is disposed at a position relative to the light-focusing mean 104 such that the red, green and blue light beams from the light-dispersing mean 106 can be reflected by the document 108 and emit into sensors such as charge-coupled devices (CCD) or complementary metal oxide semiconductor transistor (CMOS) sensors disposed in the image processing apparatus. Other single color light beams are blocked amid scanning and only the red, green and blue light beams from the light-dispersing mean 106 can emit into the sensors after being reflected by the document 108. The array of sensor for sensing the red, green and blue light beams refracted by the light-dispersing mean 106 and reflected by the document 108 is shown in FIG. 3. FIG. 3 shows a typical array of sensor comprising a red light sensitive region 302, a green light sensitive region 304 and a blue light sensitive region 306. There are multiple arrays of image sensor in an mage processing apparatus. The light-dispersing mean 106 is disposed at a position relative to the light-focusing mean 104 such that at the red, green and blue light beams refracted by the light-dispersing mean 106 and reflected by the document 108 can expose on the red light sensitive region 302, the green light sensitive region 304 and the blue light sensitive region 306 respectively. In order to render the red, green and blue color light beams emitting right on the red light sensitive region 302, the green light sensitive region 304 and the blue light sensitive region 306 respectively, the refraction rate of the red, green and blue light beams in the light-dispersing mean 106 and the reflection angle on the document 108 are calculated and the relative position between the light-dispersing mean 106, the light-focusing mean 104 and the document 108 is adjusted. When the efficiency of light energy use and the intensity of the light source are not the major considerations, the light-focusing mean 104 may be omitted. The light module 100 merely utilizes the light-dispersing mean 106 to disperse the scattering light from the light source to form red, green and blue light beams to illuminate a document to be scanned, and the red, green and the blue light sensitive regions are used to sense and receive the red, green and blue light beams reflected from the document.

The light-focusing mean 104 and the light-dispersing mean 106 are only example of the light focusing and dispersing mean of the invention. The light focusing and dispersing mean need not to be divided into a light-focusing mean and a light-dispersing mean respectively. The light focusing and dispersing mean concentrates the light emitting from a light source to form a light beam and disperses the light beam to form red, green and blue light beams illuminating a document to be scanned, wherein the red, green and blue light beams reflect to a plurality arrays of image sensors.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claim is:

1. A light focusing and dispersing apparatus of a light source module, said light focusing and dispersing apparatus comprising:
a holder having a light source; and
a light focusing and dispersing mean for concentrating light emitting from said light source to form a light beam and dispersing said light beam to form red, green and blue light beams illuminating a document to be scanned, wherein said red, green and blue light beams reflect to a plurality arrays of image sensors.

2. The light focusing and dispersing apparatus of a light source on module according to claim 1, wherein said light source comprises light-emitting diodes.

3. The light focusing and dispersing apparatus of a light source module according to claim 1, wherein said light focusing and dispersing mean comprises a convex lens.

4. The light focusing and dispersing apparatus of a light source module according claim 1, wherein said light focusing and dispersing mean comprises a convex lens.

5. The light focusing and dispersing apparatus of a light source module according to claim 1, wherein said light focusing and dispersing mean comprises a prism.

6. The light focusing and dispersing apparatus of a light source module according to claim 1, wherein said image sensors comprise charge-coupled devices.

7. The light focusing and dispersing apparatus of a light source module according to claim 1, wherein said image sensors comprise complementary metal oxide semiconductor transistors.

8. A light source module having light focusing and dispersing apparatuses, said light source comprising:
a holder having a light source;
a light-focusing mean, wherein said light-focusing mean concentrates light emitting from said light source to form a light beam;
and a light-dispersing mean, wherein said light-dispersing mean disperses said light beam to form red, green and blue light beams illuminating a document to be scanned and being reflected by the document and emitting not a plurality arrays of image sensors, each array comprising a red light sensitive region, a green light sensitive region and a blue light sensitive region for sensing red, green and blue light beams respectively.

9. The light source module according to claim 8, wherein said light source comprises light-emitting diodes.

10. The light source module according to claim 8, wherein said light source comprises a cold-cathode fluorescent lamp.

11. The light source module according to claim 8, wherein said light-focusing mean comprises a convex lens.

12. The light source module according to claim 8, wherein said image sensors comprise charge-coupled devices.

13. The light source module according to claim 8, wherein said image sensors comprise complementary metal oxide semiconductor transistors.

14. A light source module having a light focusing apparatus, said light source module comprising:
as a holder having a light source;
a light-dispersing mean, wherein said light-dispersing mean disperses the light from said light source to form red, green and blue light beams illuminating a document to be scanned and being reflected by the document and emitting into a plurality arrays of image sensors, each array comprising a red light sensitive region, a green light sensitive region and a blue light sensitive region for sensing said red, green and blue light beams respectively.

15. The light source module according to claim 14, wherein said light source comprises light-emitting diodes.

16. The light source module according to claim 14, wherein said light source comprises a cold-cathode fluorescent lamp.

17. The light source module according to claim 14, wherein said light-dispersing mean comprises a prism.

18. The light source module according to claim 14, wherein said image sensors comprise charge-coupled devices.

19. The light source module according to claim 14, wherein said image sensors comprise complementary metal oxide semiconductor transistors.
